(19) United States
(12) Patent Application Publication
(10) Pub. No.: US 2022/0343412 A1
(43) Pub. Date: Oct. 27, 2022

(54) VEHICLE RENTAL APPLICATION

(71) Applicant: Charles William Hazleton, Kingston (CA)

(72) Inventor: Charles William Hazleton, Kingston (CA)

(21) Appl. No.: 17/675,339

(22) Filed: Feb. 18, 2022

Related U.S. Application Data
(60) Provisional application No. 63/177,467, filed on Apr. 21, 2021.

(51) Int. Cl. G06Q 30/06; G06Q 50/30; G06Q 50/00

(52) U.S. Cl. CPC G06Q 30/0645; G06Q 50/30; G06Q 50/01; G06Q 30/0282

(57) ABSTRACT

A vehicle rental application is provided. A vehicle rental application executed on a processor of a computing device, for allowing a plurality of renters to list personally owned vehicles for rental and for allowing a plurality of rentees to access personally owned vehicles to rent across a plurality of locations comprising a display module of the computing device capable of displaying one or more vehicle categories comprising personally owned vehicles related to a GPS defined area, a price list for renting each of the personally owned vehicles, a rental history for the plurality of renters, a rental history for the plurality of rentees, availability for renting each of the personally owned vehicles and one or more reviews and a database, coupled to the application, for storing vehicle categories, price lists, personally owned vehicles rental availability, reviews and rental history of the plurality of renters and rentees.

### FIELD OF THE INVENTION

The present disclosure relates to a vehicle rental application more specifically, but not by way of limitation, more particularly to a vehicle rental application that allows users to list their personal vehicles and equipment for rental, facilitates the rental of these vehicles and equipment while providing users comprehensive information on the rental vehicles and other users of the vehicle rental application.

### BACKGROUND

U.S. Pat. No. 5,289,369 A (Hirshberg) discloses an automated car-rental system. Shortcomings include an inability to confirm required auto licenses, insurance and signed waivers, not tailored to contractors, strictly for cars, doesn't allow for users to list personally owned vehicles, does not link with social media accounts, does not facilitate refunds or damage claims and does not provide of a user review or rental history.

U.S. Pub. No. 2002/0186144 A1 (Meunier) discloses a system and method for automating a vehicle rental process. Shortcomings include an inability to confirm required auto licenses, insurance and signed waivers, not tailored to contractors, strictly for cars, doesn't allow for users to list personally owned vehicles, does not link with social media accounts, does not facilitate refunds or damage claims and does not provide of a user review or rental history.

U.S. Pub. No. 2012/0330696 A1 (Clark et al.) discloses an online site for owners of assets and borrowers of assets to arrange sharing transactions with respect to the assets. Shortcomings include an inability to confirm required auto licenses and signed waivers, the site is not tailored to contractors, strictly for cars and does not link with social media accounts.

U.S. Pub. No. 2013/0325521 A1 (Jameel et al.) discloses a shared vehicle rental system including vehicle availability determination. Shortcomings include an inability to confirm signed waivers and the system is not tailored to contractors.

CA Pat. No. 2,874,503 C (Jefferies et al.) discloses a rental/car-share vehicle access and management system and method. Shortcomings include an inability to confirm required auto licenses, insurance and signed waivers, not tailored to contractors, strictly for cars, doesn't allow for users to list personally owned vehicles, does not link with social media accounts, does not facilitate refunds or damage claims and does not provide of a user review or rental history.

CN Pub. No. 107,330,756 A (Yang) discloses a shared vehicle and profit distribution method. Shortcomings include an inability to confirm required auto licenses and signed waivers, not tailored to contractors, strictly for cars, does not link with social media accounts and does not provide of a user review or rental history.

CN Pub. No. 107,437,275 A (Pan et al.) discloses a private car leasing system based on parking lot management. Shortcomings include an inability to confirm required auto licenses and signed waivers, not tailored to contractors, strictly for cars, does not link with social media accounts, does not facilitate refunds or damage claims and does not provide of a user review or rental history.

JP Pub. No. 2004/220105 A (Miyashita) discloses a shared vehicle management system. Shortcomings include an inability to confirm required insurance and signed waivers, not tailored to contractors, doesn't allow for users to list personally owned vehicles, does not link with social media accounts, does not facilitate refunds or damage claims and does not provide of a user review or rental history.

KR Pub. No. 2013/0041865 A (Jo) discloses a vehicle rental system using a smart phone application. Shortcomings include an inability to confirm required auto licenses, insurance and signed waivers, not tailored to contractors, strictly for cars, doesn't allow for users to list personally owned vehicles, does not link with social media accounts, does not facilitate refunds or damage claims and does not provide of a user review.

TW Pub. No. 2020/11321 A (Lu) discloses an online shared car rental system. Shortcomings include an inability to confirm required signed waivers, not tailored to contractors, strictly for cars, doesn't allow for users to list personally owned vehicles, does not link with social media accounts, does not facilitate damage claims and does not provide of a rental history.

All documents cited herein are incorporated by reference.

There is a need for a vehicle rental application that provides connects individuals such as travelers, contractors or regular citizens who are seeking rental vehicles with individuals who are seeking to rent out their personal vehicles that facilitates the booking of rental vehicles, payment transaction between renters and rentees, pick up and drop off, insurance, license and waiver confirmation, provides user ratings and reviews and rental history.

### BRIEF SUMMARY

It is the object of the present invention to provide a vehicle rental application. A vehicle rental application executed on a processor of a computing device, for allowing a plurality of renters to list personally owned vehicles for rental and for allowing a plurality of rentees to access personally owned vehicles to rent across a plurality of locations comprising a display module of the computing device capable of displaying one or more vehicle categories comprising personally owned vehicles related to a GPS defined area, a price list for renting each of the personally owned vehicles, a rental history for the plurality of renters, a rental history for the plurality of rentees, availability for renting each of the personally owned vehicles and one or more reviews and a database, coupled to the application, for storing vehicle categories, price lists, personally owned vehicles rental availability, reviews and rental history of the plurality of renters and rentees.

In accordance with an embodiment of the invention, the price list is per hour.

In accordance with an embodiment of the invention, the price list is per day.

In accordance with an embodiment of the invention, the availability is displayed in a calendar view.

In accordance with an embodiment of the invention, the vehicle rental application facilitates one or more payment transactions between the plurality of renters and the plurality of rentees.

In accordance with an embodiment of the invention, the vehicle rental application facilitates one or more pick up and drop off scheduling between the plurality of renters and the plurality of rentees.

In accordance with an embodiment of the invention, the plurality of renters may set customized rules for the plurality of rentees to follow while renting the personally owned vehicle.

In accordance with an embodiment of the invention, the vehicle rental application allows for the plurality of renters to optionally link the one or more personally owned vehicles listed for rental to one or more social media platforms.

In accordance with an embodiment of the invention, the vehicle rental application allows for the plurality of rentees to optionally link the one or more personally owned vehicles rented to one or more social media platforms.

In accordance with an embodiment of the invention, the vehicle rental application allows for the plurality of renters to optionally link the one or more reviews to one or more social media platforms.

In accordance with an embodiment of the invention, the vehicle rental application allows for the plurality of rentees to optionally link the one or more reviews to one or more social media platforms.

In accordance with an embodiment of the invention, the vehicle rental application allows for the plurality of renters to optionally link the rental history to one or more social media platforms.

In accordance with an embodiment of the invention, the vehicle rental application allows for the plurality of rentees to optionally link the rental history to one or more social media platforms.

In accordance with an embodiment of the invention, the vehicle rental application allows for the plurality of renters to request compensation in an event where the one or more personally owned vehicles were returned in poor or unworkable condition.

In accordance with an embodiment of the invention, the vehicle rental application allows for the plurality of rentees to request compensation in an event where the one or more personally owned vehicles are in poor or unworkable condition.

In accordance with an embodiment of the invention, the compensation is approved by an administrator for the vehicle rental application.

In accordance with an embodiment of the invention, the rentee accesses the vehicle rental application via a smart device.

In accordance with an embodiment of the invention, the renter accesses the vehicle rental application via a smart device.

In accordance with an embodiment of the invention, the smart device is from the group consisting of a smart phone, a tablet and a computer.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention describes a vehicle rental application that overcomes disadvantages inherent in the known methods and systems of vehicle rental. The present invention provides a vehicle rental application, particularly an application, utilizing a database of one or more personally owned vehicles listed for rental to facilitate an additional revenue stream for renters, individuals who own the one or more vehicles listed for rent, and cheaper options for rentees, individuals who pay the renter to access the one or more vehicles listed for rent, to access vehicles. As such, the general purpose of the present invention, which will be described subsequently in greater detail, is to provide a new and improved a vehicle rental application which has all the advantages of the automotive service pricing tools and none of the disadvantages.

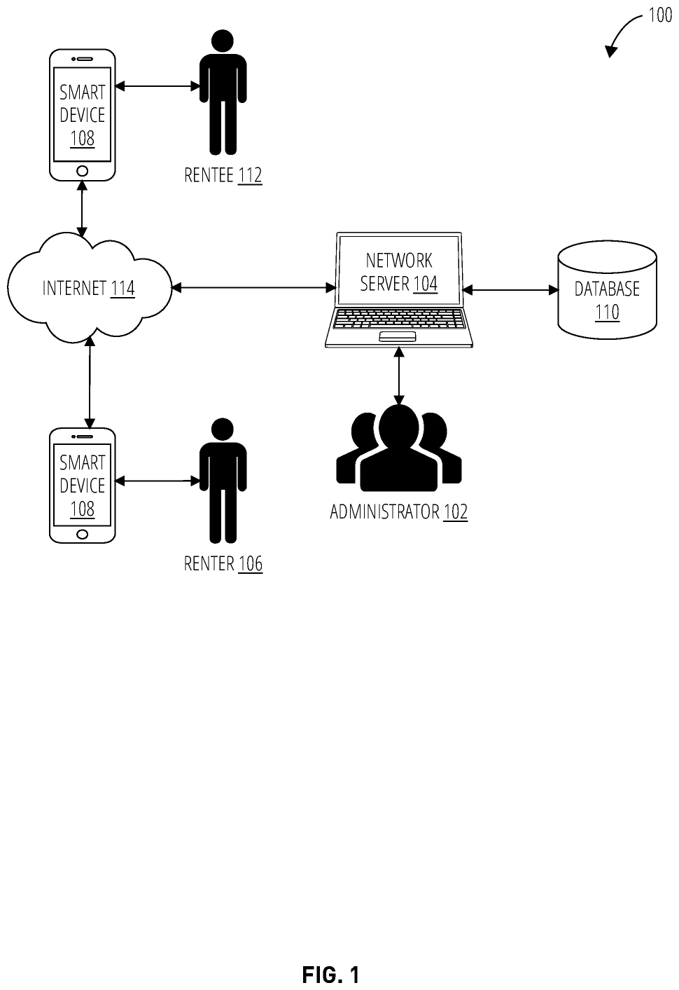

FIG. 1 provides a high level diagram 100 of a vehicle rental application as in one embodiment. An administrator 102 establishes a list of vehicles and associated rental costs on a network server 104 based on a cost inputted by each individual renter 106 who owns the vehicle via a smart device 108 connected to the network server 104 via the internet 114, with all associated information from the vehicle rental application stored in a database 110. A smart device 108 may include, but is not limited to a smart phone, tablet and computer.

A rentee 112 may access the vehicle rental application on a smart device 108, such a cell phone, tablet, computer or other similar device known in the art, connected to the network server 104 via the internet 114. Rentees 112 may request information on one or more of the listed vehicles from the network server 104 for retrieval from the database 110 or input information to network server 104 and to the database 110 for future reference.

The vehicle rental application is executed on a processor of a computing device, such as the smart devices 108 shown, for allowing a plurality of users, such as renters 106, to list one or more personally owned vehicles for rental and a plurality of users, such as rentees 112, to access the one or more personally owned vehicles to rent across a plurality of locations. The vehicle rental application comprises a display module of the computing device capable of displaying one or more vehicle categories comprising the personally owned vehicles related to a GPS defined area, a price list for renting each of the personally owned vehicles, a rental history for said plurality of renters 106, a rental history for said plurality of rentees 112, availability for renting each of said personally owned vehicles and one or more reviews and a database 110, coupled to the application, for storing the vehicle categories, the price lists, the one or more personally owned vehicles rental availability, the one or more reviews and the rental history of said plurality of users.

Providing reviews for both the renters 106 and the rentees 112 is an important feature as it allows future renters 106 to evaluate how well individual rentees 112 have cared for rented vehicles in the past as well as allows future rentees 112 to evaluate how well individual renters 106 have cared for rented vehicles in the past. In some embodiments, the vehicle rental application allows for the plurality of renters to request damage funds in an event where the personally owned vehicles were returned in poor or unworkable condition. In some embodiments, the vehicle rental application allows for the plurality of rentees to request a refund in an event where the personally owned vehicles are in poor or unworkable condition. Any requests for damage funds or refund must be approved by the administrator 102 of the vehicle rental application. Renters 106 and rentees 112 must sign up for accounts to the website by inputting one or more personal data such as, but not limited to, name, pictures, date of birth, email, address, city, province, state, territory, country, zip code, postal code, credit card information, username and password.

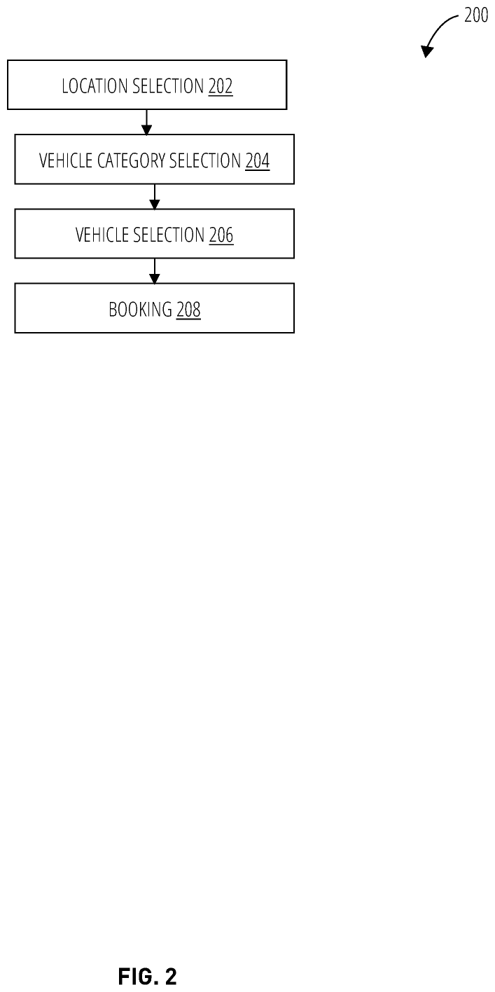

FIG. 2 provides a rentee workflow 200 of a vehicle rental application as in one embodiment. Once the rentee 112 has signed up for an account on the vehicle rental application the rentee 112 inputs location selection 202, vehicle category selection 204, vehicle selection 206 and finally booking 208. The workflow for the renter 106 follows a similar path, inputting the location of where their one or more personally owned vehicles can be picked up and dropped off and inputting information on their one or more personally owned vehicles into vehicle rental application. In some embodiments, the renters 106 can post customized rules for the rentees 112 to follow with respect to the rented vehicle.

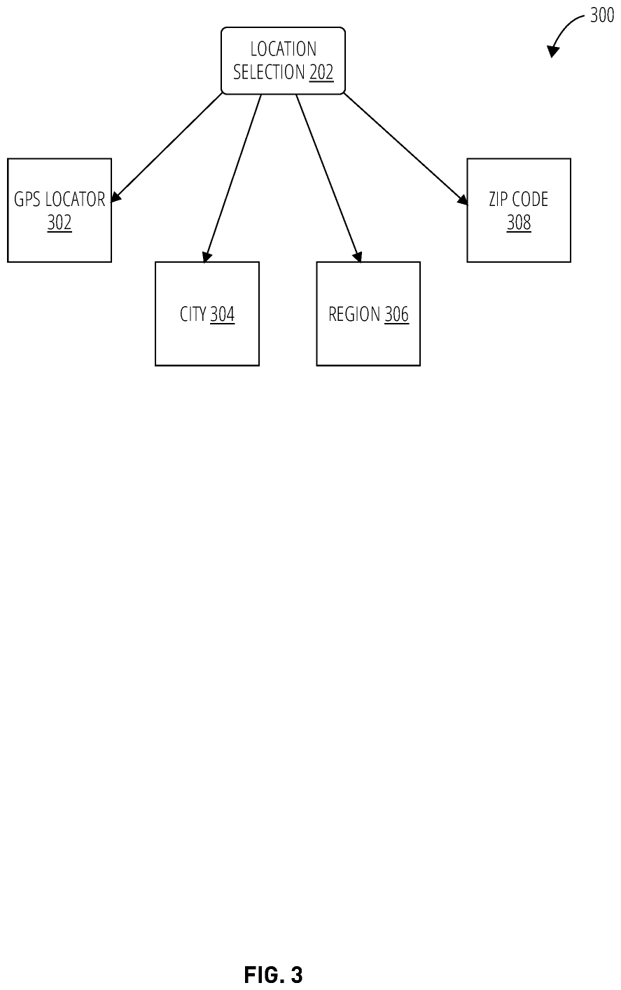

FIG. 3 provides subcategories 300 for the location selection 202 of a vehicle rental application as in one embodiment. Rentees 112 may choose from subcategories 300 such as, but not limited to, GPS locator 302, city 304, region 306 and zip code 308 to narrow the list of available vehicle rentals to their current location or a location that they plan to travel to. Similarly, renters 106 may choose from these subcategories 300 in order to list their one or more personally owned vehicles to their current location or to another location where the one or more personally owned vehicles are stored or can be moved to. In other embodiments, the subcategories 300 include postal code, province, state, territory, country and address.

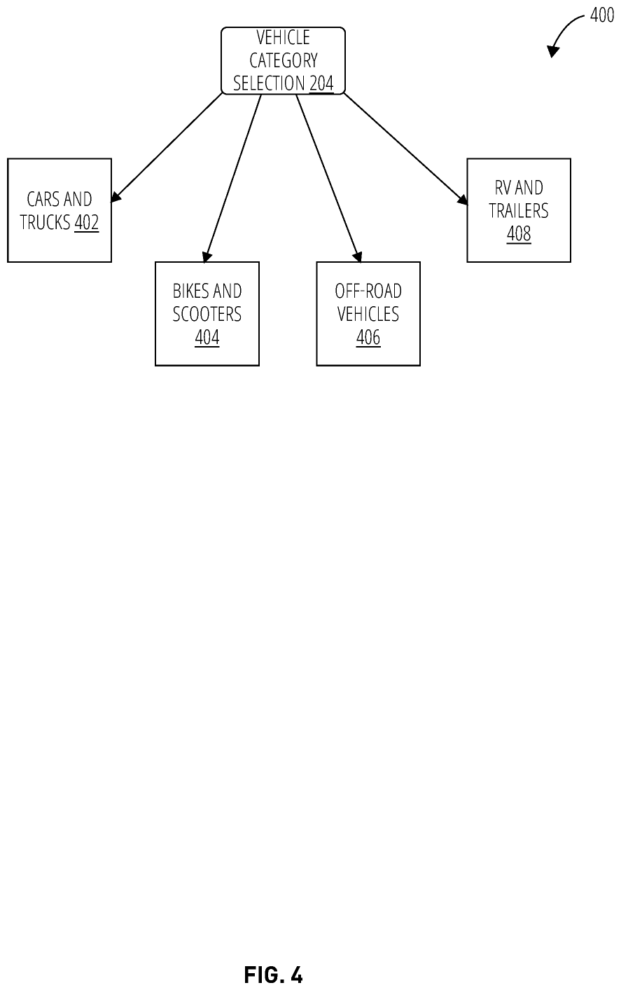

FIG. 4 provides subcategories 400 for the vehicle category selection 204 of a vehicle rental application as in one embodiment. Rentees 112 may choose from subcategories 400 such as, but not limited to, cars and trucks 402, bikes and scooters 404, off-road vehicles 406 and RV and trailers 408. Similarly, renters 106 may choose from these subcategories 400 in order to list their one or more personally owned vehicles into the appropriate vehicle category in the vehicle rental application.

Examples of cars and trucks 402 that may be listed include, but are not limited to, electric cars, luxury cars, sedans, coupes, station wagons, hatchbacks, sport utility vehicles, vans, minivans, jeeps, and trucks. Examples of bikes and scooters 404 that may be listed include, but are not limited to, electric bikes, pedal bikes, vespas and motorcycles. Examples of off-road vehicles 406 that may be listed include, but are not limited to, bulldozers, excavators, backhoe loaders, front loaders, tractors, farming and agricultural equipment, lawn mowers, all-terrain vehicles, dirt bikes, snowmobiles, scooters and dune buggies. Examples of RV and trailers 408 that may be listed include, but are not limited to, caravans, mobile homes, camper vans, camping trailers and recreational vehicles. In some embodiments, the subcategories 400 for the vehicle category selection 204 includes water vehicles. Examples of water vehicles that may be listed include, but are not limited to, canoes, kayaks, row boats, fishing boats, jet skis, speed boat, pontoon boats and house boats.

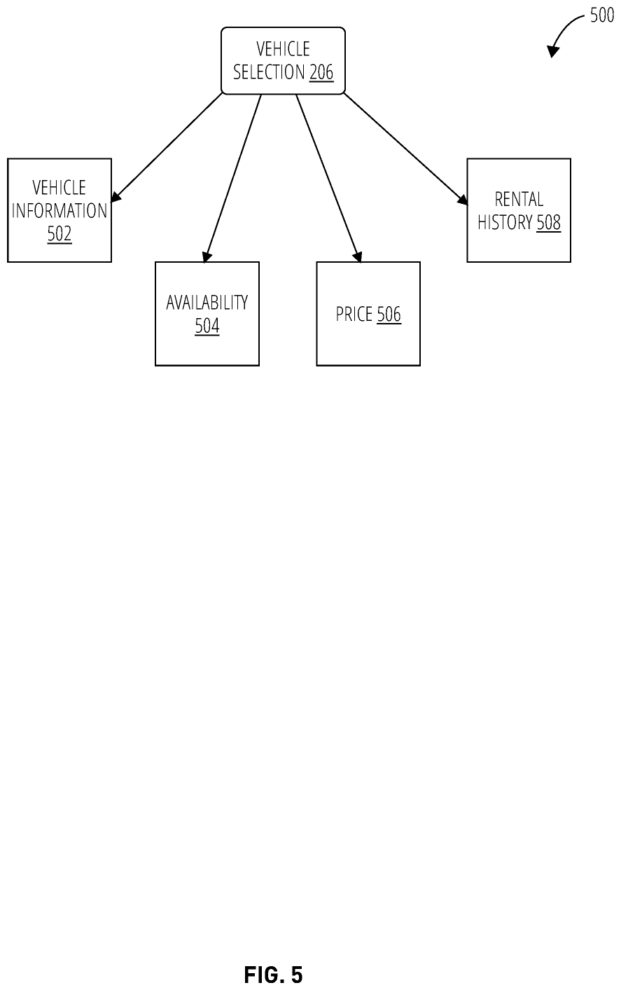

FIG. 5 provides subcategories 500 for the vehicle selection 206 of a vehicle rental application as in one embodiment. Rentees 112 may choose from subcategories 400 such as, but not limited to, vehicle information 502, availability 504, price 506 and rental history 508. The rentees 112 may utilize the information provided in these categories to compare potential rentals.

Similarly, renters 106 may choose from these subcategories 400 in order to list vehicle information 502 on their one or more personally owned vehicles, availability 504 for rental for their one or more personally owned vehicles, the price 506 for renting their one or more personally owned vehicles and the rental history 508 for their one or more personally owned vehicles. The vehicle information 502 provided by the renters 106 include, but are not limited to, the make, model and year of the personally owned vehicle, whether the personally owned vehicle is automatic, manual, electric, hybrid or motor and the type of gasoline required.

In some embodiments, the availability 504 provided by the renters 106 is displayed in a calendar view. In some embodiments, the vehicle rental application facilitates one or more payment transactions between the plurality of renters 106 and the plurality of rentees 112. In some embodiments, the price 506 provided by the renters 106 is per hour. In other embodiments, the price 506 provided by the renters 106 is per day.

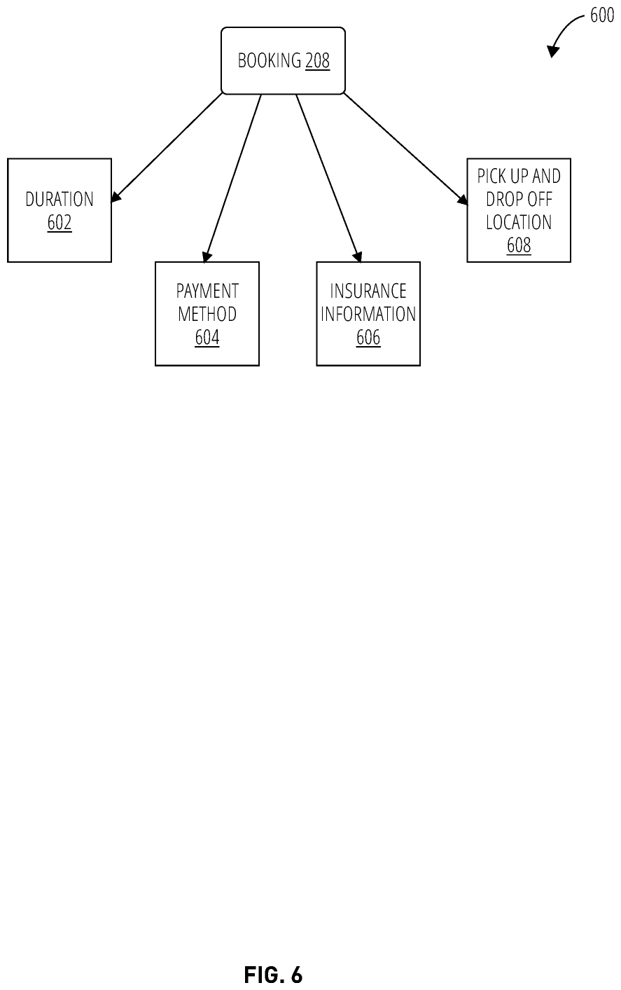

FIG. 6 provides subcategories 600 for the booking 208 of a vehicle rental application as in one embodiment. Rentees 112 may choose from subcategories 600 such as, but not limited to, duration 602, payment method 604, insurance information 606 and pick up and drop off location 608. In some embodiments, the rentees 112 can customize the search for the rental vehicles availability, location and associated costs. The plurality of rentees 112 are required to provide proof of auto insurance, applicable driving licenses and sign a waiver such that the renter 106 is not liable prior to booking.

In some embodiments, the vehicle rental application facilitates one or more pick up and drop off scheduling between the plurality of renters 106 and the plurality of rentees 112. In some embodiments, the vehicle rental application allows for the plurality of renters 106 and the rentees 112 to optionally link the one or more personally owned vehicles listed for rental to one or more social media platforms. This allows further advertising for the plurality of renters 106 as well as also both the plurality of renters 106 and the plurality of rentees 112 to share this information to various social media communities. In some embodiments, the vehicle rental application allows for the plurality of renters 106 and the plurality of rentees 112 to optionally link the one or more reviews to one or more social media platforms. This allows further advertising for the plurality of renters 106 as well as provides transparency between the plurality of renters 106 and the plurality of rentees 112. In some embodiments, the vehicle rental application allows for the plurality of renters 106 and the plurality of rentees 112 to optionally link rental histories 508 to one or more social media platforms. This allows further advertising for the plurality of renters 106, allows the plurality of renters 106 and the plurality of rentees 112 to share this information to various social media communities as well as provides transparency between the plurality of renters 106 and the plurality of rentees 112.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A vehicle rental application executed on a processor of a computing device, for allowing a plurality of renters to list one or more personally owned vehicles for rental and for allowing a plurality of rentees to access said one or more personally owned vehicles to rent across a plurality of locations, comprising:
a display module of said computing device capable of displaying one or more vehicle categories comprising said personally owned vehicles related to a GPS defined area, a price list for renting each of said personally owned vehicles, a rental history for said plurality of renters, a rental history for said plurality of rentees, availability for renting each of said personally owned vehicles and one or more reviews; and
a database, coupled to said application, for storing said vehicle categories, said price lists, said one or more personally owned vehicles rental availability, said one or more reviews and said rental history of said plurality of renters and said plurality of rentees.

2. The vehicle rental application of claim 1, wherein said price list is per hour.

3. The vehicle rental application of claim 1, wherein said price list is per day.

4. The vehicle rental application of claim 1, wherein said availability is displayed in a calendar view.

5. The vehicle rental application of claim 1, wherein said vehicle rental application facilitates one or more payment transactions between said plurality of renters and said plurality of rentees.

6. The vehicle rental application of claim 1, wherein said vehicle rental application facilitates one or more pick up and drop off scheduling between said plurality of renters and said plurality of rentees.

7. The vehicle rental application of claim 1, wherein said plurality of renters may set customized rules for said plurality of rentees to follow while renting said personally owned vehicle.

8. The vehicle rental application of claim 1, wherein said vehicle rental application allows for said plurality of renters to optionally link said one or more personally owned vehicles listed for rental to one or more social media platforms.

9. The vehicle rental application of claim 1, wherein said vehicle rental application allows for said plurality of rentees to optionally link said one or more personally owned vehicles rented to one or more social media platforms.

10. The vehicle rental application of claim 1, wherein said vehicle rental application allows for said plurality of renters to optionally link said one or more reviews to one or more social media platforms.

11. The vehicle rental application of claim 1, wherein said vehicle rental application allows for said plurality of rentees to optionally link said one or more reviews to one or more social media platforms.

12. The vehicle rental application of claim 1, wherein said vehicle rental application allows for said plurality of renters to optionally link said rental history to one or more social media platforms.

13. The vehicle rental application of claim 1, wherein said vehicle rental application allows for said plurality of rentees to optionally link said rental history to one or more social media platforms.

14. The vehicle rental application of claim 1, wherein said vehicle rental application allows for said plurality of renters to request compensation in an event where said one or more personally owned vehicles were returned in poor or unworkable condition.

15. The vehicle rental application of claim 1, wherein said vehicle rental application allows for said plurality of rentees to request compensation in an event where said one or more personally owned vehicles are in poor or unworkable condition.

16. The vehicle rental application of claim 14 or 15, wherein said refund is approved by an administrator for said vehicle rental application.

17. The vehicle rental application of claim 1, wherein said rentee accesses said vehicle rental application via a smart device.

18. The vehicle rental application of claim 17, wherein said smart device is from the group consisting of a smart phone, a tablet and a computer.

19. The vehicle rental application of claim 1, wherein said renter accesses said vehicle rental application via a smart device.

20. The vehicle rental application of claim 19, wherein said smart device is from the group consisting of a smart phone, a tablet and a computer.
